(19) United States
(12) Patent Application Publication
(10) Pub. No.: US 2021/0400996 A1
(43) Pub. Date: Dec. 30, 2021

(54) PREPARATION METHOD OF BIO-FERMENTED LIQUID FEED, BIO-FERMENTED LIQUID FEED AND BIO-FERMENTED EMULSION LIQUID FEED

(71) Applicant: Tangrenshen Group Co.,Ltd., Zhuzhou (CN)

(72) Inventors: Xiaoming Wang, Zhuzhou (CN); Dun Deng, Zhuzhou (CN); Jiancheng Shu, Zhuzhou (CN); Xiangshan Tang, Zhuzhou (CN); Jie Luo, Zhuzhou (CN)

(73) Assignee: Tangrenshen Group Co.,Ltd., Zhuzhou (CN)

(21) Appl. No.: 17/038,206

(22) Filed: Sep. 30, 2020

(30) Foreign Application Priority Data
Jun. 24, 2020 (CN) 202010590206.X

(51) Int. Cl. A23K 10/12; A23K 10/14; A23K 10/16; A23K 20/147; A23K 20/158; A23K 50/30

(52) U.S. Cl. CPC A23K 10/12; A23K 10/14; A23K 50/30; A23K 20/147; A23K 20/158; A23K 10/16

(57) ABSTRACT

The application relates to a preparation method of liquid bio-fermented feed, liquid bio-fermented feed and bio-fermented emulsion liquid feed, belonging to the technical field of feed preparation. The preparation method of the present application may overcome physiological problems of weaned piglets such as insufficient gastric acid secretion, low content and activity of digestive enzymes, incomplete development of immune system, disorder of intestinal microecosystem, and the like. The prepared bio-fermented liquid feed has good palatability and high nutrition, easy digestion, low acidity, and is a liquid feed similar to breast milk, which can both effectively alleviate the weaning stress syndrome of piglets, and effect a seamless transition from breast milk to conventional solid feed.

### CROSS REFERENCE TO RELATED APPLICATION

This application claims the priority of Chinese Patent Application No. 202010590206.X, entitled “Preparation method of bio-fermented liquid feed, bio-fermented liquid feed and bio-fermented emulsion liquid feed” filed with China National Intellectual Property Administration on Jun. 24, 2020, which is incorporated herein by reference in its entirety.

### TECHNICAL FIELD

The application relates to the technical field of feed preparation, in particular to a preparation method of bio-fermented liquid feed, bio-fermented liquid feed and bio-fermented emulsion liquid feed.

### BACKGROUND ART

In order to improve the production efficiency of sows and the utilization rate of shed, most pig farms now adopt early weaning of piglets in the production technology. However, after early weaning, affected by changes in nutrition, physiology, psychology, environment and many other factors, piglets often suffer from weaning stress syndrome, such as no feeding or low feed intake, diarrhea, low immunity and susceptibility to illness.

After weaning, the feed intake of piglets will inevitably decrease due to the sudden change of food from liquid breast milk to solid feed. The dry matter content of breast milk is only 20%, and these dry matter are composed of lactose, cream and lactoprotein, which are highly digestible. Most of the creep feed contain a lot of starch and plant protein, which are uneasy to digest. Newly weaned piglets have problems of insufficient gastric acid secretion, low digestive enzyme content and activity, incomplete immune system development, and disordered intestinal microecosystem. Weaning stress problems cannot be effectively solved.

### SUMMARY OF THE APPLICATION

The purpose of the present application is to provide a preparation method of bio-fermented liquid feed, bio-fermented liquid feed and bio-fermented emulsion liquid feed, which may overcome the physiological problems of weaned piglets, such as insufficient gastric acid secretion, low digestive enzyme content and activity, incomplete immune system development, and disordered intestinal microecosystem. The bio-fermented liquid feed provided by the present application has advantages of good palatability, high nutrition, easy digestion, low acidity and similarity to breast milk, which may both effectively alleviate the weaning stress syndrome of piglets, and effect a seamless transition from breast milk to conventional solid feed.

The application provides a preparation method of bio-fermented liquid feed, including the following steps:

1) mixing corn, broken rice, barley and wheat in a weight ratio of 1:(0-5):(0-5):(0-5) to obtain a first substrate of enzymolysis;

2) mixing the first substrate of enzymolysis obtained in step 1) with water, adding α-amylase according to the ratio of 1-1500 U per gram of the first substrate of enzymolysis, and raising the temperature to 60-120° C. for liquefaction enzymatic hydrolysis for 10-120 min to obtain a first enzymolysis slurry A;

3) adjusting the temperature of the first enzymolysis slurry A obtained in step 2) to 40-80° C., adding β-amylase according to the ratio of 0-2000 U per gram of the first substrate of enzymolysis, adding pullulanase according to the ratio of 0-100 ASPU per gram of the first substrate of enzymolysis, adding glucoamylase according to the ratio of 0-5000 U per gram of the first substrate of enzymolysis, adding xylanase according to the ratio of 0-1000 U per gram of the first substrate of enzymolysis, adding 3-glucanase according to the ratio of 0-1000 U per gram of the first substrate of enzymolysis, and enzymolyzing for 0-72 h to obtain a second enzymolysis slurry A;

4) adjusting the temperature of the second enzymolysis slurry A obtained in step 3) to 25-40° C., adding Lactobacillus according to the ratio of 1×10⁵-1×10⁸ cfu per gram of the first substrate of enzymolysis, adding neutral protease according to the ratio of 1-1000 U per gram of the first substrate of enzymolysis, adding acid protease according to the ratio of 1-1000 U per gram of the first substrate of enzymolysis, and performing anaerobic fermentation for 10-72 h to obtain a component A;

5) mixing and sterilizing the soybean meal and water, adjusting the temperature to 40-70° C., adjusting the pH to 7-10, adding alkaline protease according to the ratio of 1-10000 U per gram of soybean meal, enzymolyzing for 0.5-6 h, then adjusting the pH to 6-8, adding neutral protease according to the ratio of 1-1000 U per gram of soybean meal, and enzymolyzing for 0.5-6 hours to obtain a first enzymolysis slurry B;

6) adjusting the temperature of the first enzymolysis slurry B obtained in step 5) to 25-40° C., adding Lactobacillus according to the ratio of 1×10⁵-1×10⁸ cfu per gram of soybean meal, and adding acid protease according to the ratio of 1-1000 U per gram of soybean meal, performing anaerobic fermentation for 10-72 h to obtain a component B;

7) mixing the component A obtained in step 4) and the component B obtained in step 6) with a base material to obtain a bio-fermented liquid feed; the base material includes the following components by mass percentage: 0-20% quick-breaking soybeans or puffed soybeans, 1-10% fish meal, 0-10% intestinal membrane protein powder, 1-10% yeast extract, 0-10% chocolate powder, 1-50% whey powder, 1-50% whole milk powder, 0-10% glucose, 1-20% sucrose, 0.1-5% calcium hydrogen phosphate, 0.1-5% calcium formate, 0.1-10% fat powder and 2-10% premix feed;

The step 1) and the step 5) are not limited in time sequence.

In an embodiment, the corn, broken rice, barley and wheat in step 1) and the soybean meal in step 5) are crushed before being mixed with water.

In an embodiment, in step 1), the weight ratio for mixing the first substrate of enzymolysis and water is 1:(1-10).

In an embodiment, the weight ratio for mixing the soybean meal and water in step 5) is 1:(1-20).

In an embodiment, in step 7), the weight ratio for mixing component A, component B and base material is 100:(10-1000):(10-100).

The application also provides a bio-fermented liquid feed prepared by the preparation method described in the above technical solution.

The present application also provides a bio-fermented emulsion liquid feed based on the preparation method described in the above technical solution or the bio-fermented liquid feed described in the above technical solution. The preparation method of the bio-fermented emulsion liquid feed includes the following steps:

Grinding, emulsifying and homogenizing the bio-fermented liquid feed to obtain the bio-fermented emulsion liquid feed.

In an embodiment, the particle size of the bio-fermented emulsion liquid feed is 0.01-1000 μm.

The application provides a preparation method of bio-fermented liquid feed. The application realizes polysaccharification of starch, protein peptidization, and microemulsification of fat by processing the raw materials of the bio-fermented liquid feed with enzymatic hydrolysis technology and bio-fermented technology, thus eliminating the antigen in the feed and turning the macromolecular nutrients into abundant micromolecular nutrients, and characterizing in balanced nutrition, good palatability, easy digestion, fast absorption and the like. The bio-fermented liquid feed obtained by the preparation method of the present application has the following advantages compared with the liquid feed made mainly of milk powder and added water: (1) The feed formulation composition is similar to the conventional solid feed formulation composition, which makes it an easy transition to conventional feed and realizes the perfect transition from breast milk to conventional solid feed; (2) After the feed is fermented, a large number of probiotics, organic acids, antibacterial peptides and unknown growth-promoting factors and the like are produced, which may regulate the balance of the flora in the animal's intestines and help weaned piglets to establish a stable ecosystem dominated by probiotics; (3) Low cost and higher economic benefits.

### BRIEF DESCRIPTION OF THE DRAWINGS

FIG. 1 is a picture of piglets consuming bio-fermented liquid feed provided by the present application and conventional solid creep feed;

FIG. 2 is a picture of piglets eating bio-fermented liquid feed provided by the present application and conventional solid creep feed;

FIG. 3 is a picture of the piglets' consumption of bio-fermented liquid feed provided by the present application and conventional solid creep feed.

### DETAILED DESCRIPTION OF THE EMBODIMENTS

The application provides a preparation method of bio-fermented liquid feed, including the following steps:

1) mixing corn, broken rice, barley and wheat in a weight ratio of 1:(0-5):(0-5):(0-5) to obtain a first substrate of enzymolysis;

2) mixing the first substrate of enzymolysis obtained in step 1) with water, adding α-amylase according to the ratio of 1-1500 U per gram of the first substrate of enzymolysis, and raising the temperature to 60-120° C. for liquefaction enzymatic hydrolysis for 10-120 min to obtain a first enzymolysis slurry A;

3) adjusting the temperature of the first enzymolysis slurry A obtained in step 2) to 40-80° C., adding β-amylase according to the ratio of 0-2000 U per gram of the first substrate of enzymolysis, adding pullulanase according to the ratio of 0-100 ASPU per gram of the first substrate of enzymolysis, adding glucoamylase according to the ratio of 0-5000 U per gram of the first substrate of enzymolysis, adding xylanase according to the ratio of 0-1000 U per gram of the first substrate of enzymolysis, adding 3-glucanase according to the ratio of 0-1000 U per gram of the first substrate of enzymolysis, and enzymolyzing for 0-72 h to obtain a second enzymolysis slurry A;

4) adjusting the temperature of the second enzymolysis slurry A obtained in step 3) to 25-40° C., adding Lactobacillus according to the ratio of 1×10⁵-1×10⁸ cfu per gram of the first substrate of enzymolysis, adding neutral protease according to the ratio of 1-1000 U per gram of the first substrate of enzymolysis, adding acid protease according to the ratio of 1-1000 U per gram of the first substrate of enzymolysis, and performing anaerobic fermentation for 10-72 h to obtain a component A;

5) mixing and sterilizing the soybean meal and water, adjusting the temperature to 40-70° C., adjusting the pH to 6.5-8.5, adding alkaline protease according to the ratio of 1-10000 U per gram of soybean meal, adding neutral protease according to the ratio of 1-1000 U per gram of soybean meal, and enzymolyzing for 0.5-6 hours to obtain a first enzymolysis slurry B;

6) adjusting the temperature of the first enzymolysis slurry B obtained in step 5) to 25-40° C., adding Lactobacillus according to the ratio of 1×10⁵-1×10⁷ cfu per gram of soybean meal, and adding acid protease according to the ratio of 1-1000 U per gram of soybean meal, performing anaerobic fermentation for 10-72 h to obtain a component B;

7) mixing the component A obtained in step 4) and the component B obtained in step 6) with a base material to obtain a bio-fermented liquid feed; the base material includes the following components by mass percentage: 0-20% quick-breaking soybeans or puffed soybeans, 1-10% fish meal, 0-10% intestinal membrane protein powder, 1-10% yeast extract, 0-10% chocolate powder, 1-50% whey powder, 1-50% whole milk powder, 0-10% glucose, 1-20% sucrose, 0.1-5% calcium hydrogen phosphate, 0.1-5% calcium formate, 0.1-10% fat powder and 2-10% premix feed;

The step 1) and the step 5) are not limited in time sequence.

Corn, broken rice, barley and wheat are mixed in the present application in a weight ratio of 1:(0-5):(0-5):(0-5) to obtain the first substrate of enzymolysis. Impurities are preferably removed from the corn, broken rice, barley, and wheat of the present application before use. In the present application, the corn, broken rice, barley and wheat are preferably crushed before being mixed with water, and the particle size after crushing is preferably <1500 μm. In the present application, the weight ratio of corn, broken rice, barley and wheat is more preferably 1:(0.2-3):(0-2):(0-2). In the present application, the weight ratio for mixing the first substrate of enzymolysis and water is preferably 1:(1-10), more preferably 1:(1.5-5).

After obtaining the first substrate of enzymolysis, in the present application, the first substrate of enzymolysis are mixed with water, α-amylase is added according to the ratio of 1-1500 U per gram of the first substrate of enzymolysis, and the temperature are raised to 60-120° C. for liquefaction enzymatic hydrolysis for 10-120 min to obtain a first enzymolysis slurry A. In the present application, the order of adding water and α-amylase is not limited, either water and α-amylase can be added first. In the present application, it is more preferable to add 10 to 500 U of α-amylase per gram of the first substrate of enzymolysis. In the present application, it is more preferable to raise the temperature to 70-100° C. for 30-120 min of liquefaction enzymatic hydrolysis. By using α-amylase for liquefaction enzymatic hydrolysis, not only may the starch be enzymolyzed into dextrin, which improves the digestibility and palatability, but also the sterilization of the raw materials is completed, which is beneficial to the next step of probiotic fermentation.

After obtaining the first enzyme hydrolysis slurry A, in the present application, the temperature of the first enzymolysis slurry A is adjusted to 40-80° C., 3-amylase is added according to the ratio of 0-2000 U per gram of the first substrate of enzymolysis, pullulanase is added according to the ratio of 0-100 ASPU per gram of the first substrate of enzymolysis, glucoamylase is added according to the ratio of 0-5000 U per gram of the first substrate of enzymolysis, xylanase is added according to the ratio of 0-1000 U per gram of the first substrate of enzymolysis, β-glucanase is added according to the ratio of 0-1000 U per gram of the first substrate of enzymolysis, and the obtained mixture is enzymolyzed for 0-72 h to obtain a second enzymolysis slurry A. In the present application, the added amount of the β-amylase is more preferably 0-500 U/g substrate of enzymolysis; the added amount of the pullulanase is more preferably 0-20 ASPU/g substrate of enzymolysis; the added amount of the glucoamylase is more preferably 0-1000 U/g substrate of enzymolysis; the added amount of the xylanase is more preferably 0-100 U/g substrate of enzymolysis; the added amount of 3-glucanase is more preferably 0-100 U/g substrate of enzymolysis. Through the above enzymatic hydrolysis process, the β-amylase, pullulanase and glucoamylase may greatly increase the content of maltose and glucose in the enzymatic hydrolysis solution, thereby further improving the digestibility and palatability of the enzymatic hydrolysis solution; xylanase and β-glucanase may reduce the content of non-starch polysaccharides in the substrate of enzymolysis and improve the digestion of the substrate of enzymolysis rate once again. There is no limitation on the addition sequence of 3-amylase, pullulanase, glucoamylase, xylanase and β-glucanase in the present application.

After obtaining the second enzymolysis slurry A, in the present application, the temperature of the second enzymolysis slurry A is adjusted to 25-40° C., Lactobacillus is added according to the ratio of 1×10⁵-1×10⁸ cfu per gram of the first substrate of enzymolysis, neutral protease is added according to the ratio of 1-1000 U per gram of the first substrate of enzymolysis, acid protease is added according to the ratio of 1-1000 U per gram of the first substrate of enzymolysis, and anaerobic fermentation is performed for 10-72 h to obtain a component A. In the present application, the temperature is more preferably 35 to 38° C. In the present application, the added amount of the Lactobacillus is more preferably 1×10⁶ to 1×10⁷ cfu/g substrate of enzymolysis. In the present application, the added amount of the neutral protease is more preferably 5-100 U/g of the substrate of enzymolysis, and the added amount of the acid protease is more preferably 10-500 U/g of the substrate of enzymolysis. Using neutral protease and acid protease for enzymatic hydrolysis may enzymolyze large molecules into small peptides, and Lactobacillus fermenting may produce a large number of Lactobacillus and their metabolites (lactic acid, nisin, phenyllactic acid, etc.), which may reduce the pH value of feed, and improve its palatability and digestibility.

In the present application, the soybean meal and water are mixed and sterilized, the temperature is adjusted to 40-70° C., the pH is adjusted to 7-10, alkaline protease is added according to the ratio of 1-10000 U per gram of soybean meal, enzymolyzing for 0.5-6 h, then the pH adjusted to 6-8, neutral protease is added according to the ratio of 1-1000 U per gram of soybean meal, and the obtained mixture is enzymolyzed for 0.5-6 hours to obtain a first enzymolysis slurry B. In the present application, impurities are preferably remove from the soybean meal before use. In the present application, the soybean meal is preferably crushed before being mixed with water. In the present application, the weight ratio for mixing the soybean meal and water is preferably 1:(1-20), more preferably 1:(3-15). The sterilization method of the present application is preferably pasteurization, and more preferably, the temperature of sterilization is 60-100° C. and the time is 5-30 min. The temperature of enzymatic hydrolysis in the present application is more preferably 50-65° C. In the present application, the pH is more preferably 8-9.5 during enzymatic hydrolysis of the alkaline protease. In the present application, the added amount of the alkaline protease is more preferably 50-1000 U/g soybean meal; the added amount of the neutral protease is more preferably 5-500 U/g soybean meal. In the present application, the alkaline protease enzymatic hydrolysis time of alkaline protease is more preferably 0.5-4 hours, and the enzymatic hydrolysis time of neutral protease is more preferably 0.5-4 hours. Macromolecular proteins in soybean meal can be converted into small peptides which can be easily digested and absorbed by complex enzymolysis of alkaline protease and neutral protease.

After obtaining the first enzymolysis slurry B, in the present application, the temperature of the first enzymolysis slurry B is adjusted to 25-40° C., Lactobacillus is added according to the ratio of 1×10⁵-1×10⁸ cfu per gram of soybean meal, and acid protease is added according to the ratio of 1-1000 U per gram of soybean meal, anaerobic fermentation is performed for 10-72 h to obtain a component B. In the present application, the temperature is more preferably 35-38° C. In the present application, the added amount of the Lactobacillus is more preferably 1×10⁶-1×10⁷ cfu/g soybean meal, and the added amount of the acid amylase is more preferably 20-1000 U/g soybean meal. In the present application, the time for performing anaerobic fermentation is more preferably 20-48 hours. The yield of soybean peptides can be further improved by Lactobacillus fermentation and acid protease enzymatic hydrolysis, meanwhile a large number of Lactobacillus and their metabolites can be produced through fermentation, and also, the fermentation of Lactobacillus can eliminate both raffinose and stachyose (anti-nutritional factors) in soybean meal and most of the bitter substances produced in the process of enzymatic hydrolysis of soybean meal.

After obtaining component A and component B, in the present application, the component A and the component B are mixed with a base material to obtain a bio-fermented liquid feed; the base material includes the following components by mass percentage: 0-20% quick-breaking soybeans or puffed soybeans, 1-10% fish meal, 0-10% intestinal membrane protein powder, 1-10% yeast extract, 0-10% chocolate powder, 1-50% whey powder, 1-50% whole milk powder, 0-10% glucose, 1-20% sucrose, 0.1-5% calcium hydrogen phosphate, 0.1-5% calcium formate, 0.1-10% fat powder and 2-10% premix feed. There is no specific limitation on the source of the premix feed in the present application, and the corresponding conventional commercial premix feed selected according to the growth stage of the piglets will do. In the present application, the weight ratio for mixing the component A, the component B and the base material is preferably 100:(10-1000):(10-100).

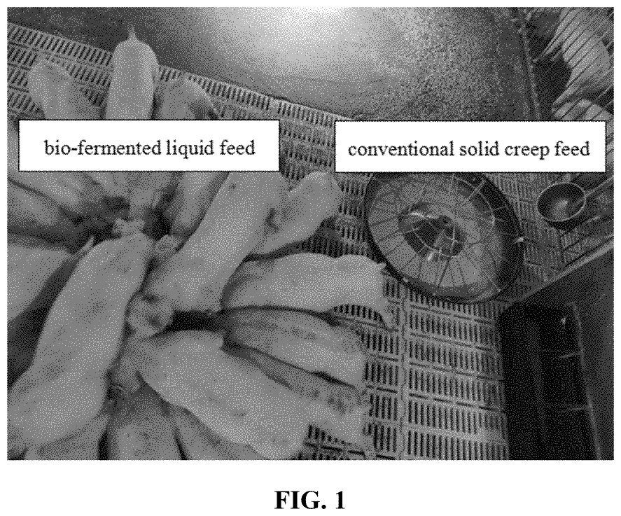

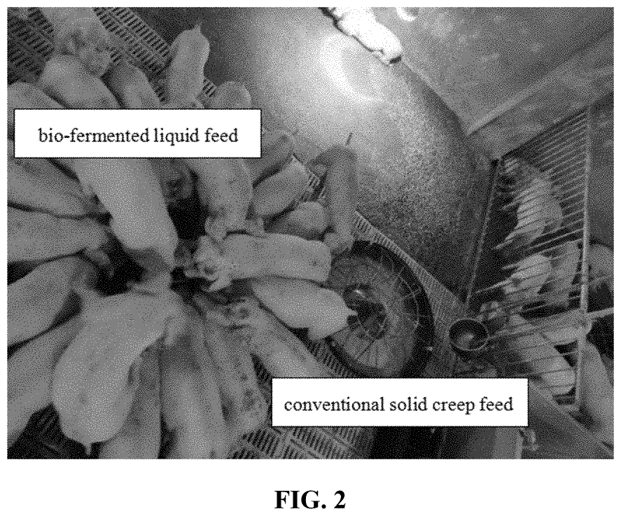

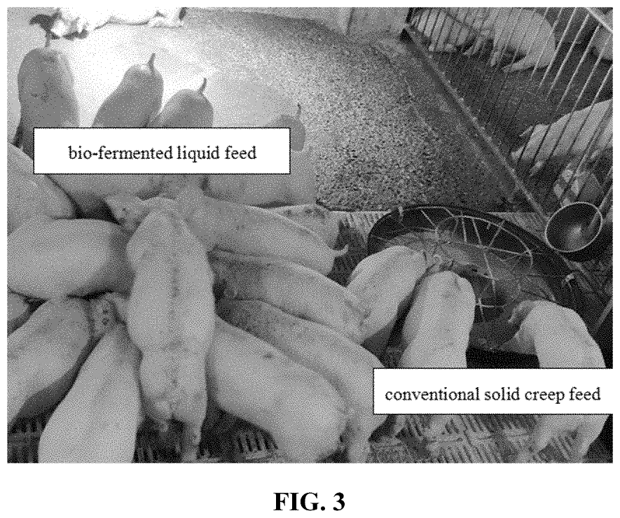

The preparation method of the present application combines enzymatic hydrolysis technology, bio-fermented technology and the like, changes macromolecular nutrients into abundant micromolecular nutrients. The bio-fermented liquid feed obtained has the characteristics of balanced nutrition and good palatability (as shown in FIG. 1, FIG. 2 and FIG. 3, wherein the left sides of FIGS. 1 to 3 show the piglets consuming the bio-fermented liquid feed of the present application, and the right sides show the consuming of conventional solid creep feed), easy digestion, fast absorption, high stability and the like. It can not only effectively relieve the weaning stress syndrome of piglets, but also realize the perfect transition from breast milk to conventional solid feed.

The application also provides a bio-fermented liquid feed prepared by the preparation method described in the above technical scheme. The bio-fermented liquid feed of the present application can be directly fed to piglets (suitable for being prepared and used in farms, and the problem of stratification will occur after being placed for more than 3 days), and can also be prepared into bio-fermented emulsion liquid feed to feed piglets.

The present application also provides an bio-fermented emulsion liquid feed based on the preparation method or the bio-fermented liquid feed of the above technical scheme, and the preparation method of the bio-fermented emulsion liquid feed includes the following steps:

Grinding, emulsifying and homogenizing the bio-fermented liquid feed to obtain the bio-fermented emulsion liquid feed. There is no specific limitation in the present application on the methods of grinding, emulsification and homogenization, and a conventional colloid mill for grinding, an emulsification pump for emulsification, and a homogenizer for homogenization will do. In the present application, the particle size of the bio-fermented emulsion liquid feed is preferably 0.01-1000 μm, more preferably 0.01-150 μm.

The grinding, homogenization and emulsification process are introduced into the present application. After the liquid feed is ground, emulsified and homogenized, the particle size of the liquid feed is greatly reduced, the palatability and digestibility of the liquid feed are effectively improved, and the problem of stratification when conventional liquid feed is placed for a long time is resolved. The emulsion liquid feed may ensure that there will be no stratification within 30 days, and only slight stratification will occur within 30 to 90 days.

The emulsion bio-fermented liquid feed of the present application has the characteristics of good palatability, good stability, and no stratification after being placed for a long time.

The preparation method of bio-fermented liquid feed, bio-fermented liquid feed and bio-fermented emulsion liquid feed of the present application will be described in further detail below with specific examples. The technical solution of the present application includes but is not limited to the following examples.

### Example 1

Impurities were removed from 300 kg of corn and 100 kg of broken rice, and corn and rice were crushed, and then mixed evenly to prepare substrate of enzymolysis. α-amylase was added into substrate of enzymolysis at 30 U/g, and then 1500 kg of water was added, mixed evenly to prepare enzymolysis slurry, which was raised to 75-80° C. for liquefaction enzymolysis for 90 min. Then, the temperature of enzymolysis slurry was adjusted to 50-55° C., and β-amylase was added into substrate of enzymolysis at 100 U/g, and pullulanase was added into substrate of enzymolysis at 0.1 ASPU/g, and the enzymolysis was carried out for 6 hours with heat preservation. Then, the temperature of enzymolysis slurry was adjusted to 35-38° C., Lactobacillus was added into substrate of enzymolysis at 1×10⁶ CFU/g, neutral protease was added into substrate of enzymolysis at 20 U/g, and acid protease was added into substrate of enzymolysis at 30 U/g, and then anaerobic fermentation was carried out for 28 h under heat preservation, thus obtaining the component A.

Impurities were removed from 100 kg of soybean meal and soybean meal was crushed, 1000 kg of water was added and mixed evenly, and then the temperature was raised to 70-75° C., and the temperature was kept for 20 min for sterilization. Then, the temperature of the sterilized soybean meal solution was adjusted to 50-55° C., the pH was adjusted to 8.0-8.5 before the alkaline protease was added into soybean meal at 100 U/g, the temperature was kept for 2 hours for enzymolysis, and then the pH was adjusted to 7-7.5, neutral protease was added into soybean meal at 50 U/g, and mixed evenly to prepare enzymatic hydrolysis solution, and the temperature was kept for enzymolysis for 2 h. The temperature of the enzymolysis slurry was adjusted to 35-38° C., Lactobacillus was added into substrate of enzymolysis at 3×10⁶ CFU/g, acid protease was added into substrate of enzymolysis at 80 U/g, and then anaerobic fermentation was carried out for 36 h under heat preservation, thus obtaining the component B.

1900 kg of component A, 1100 kg of component B and 500 kg of base material were mixed evenly to obtain bio-fermented liquid feed (complete bio-fermented liquid feed), wherein 500 kg of base material was obtained by evenly mixing the following raw materials: 16% puffed soybeans, 6% fish meal, 4% yeast extract, 21% whey powder, 30% whole milk powder, 10% sucrose, 1.4% calcium hydrogen phosphate, 1% calcium formate, 4.6% fat powder and 6% premix feed.

The complete bio-fermented liquid feed was ground by colloid mill, then emulsified by emulsifying pump, finally homogenized by homogenizer to obtain a bio-fermented emulsion liquid feed with a particle size of 0.1-100 μm.

Animal Experiment:

100 weaned piglets aged 21 days were randomly divided into 2 treatment groups according to the principle of similar weight and the same sex, with 5 replicates in each treatment and 10 piglets in each replicate. Two kinds of experimental diets were fed separately: experimental feed A (control group, solid creep feed), experimental feed B (experimental group, bio-fermented emulsion liquid feed). During the experiment period, a dedicated person was arranged to be in charge of the feeding, piglets were kept in a naturally ventilated environment and free to eat and drink, and the shed was kept clean and sanitary. During the experiment period, if the piglets were found sick, they were treated in time, and if a piglet could not recover within 3 days, it was eliminated. A 7-day experiment was carried out (21 days old to 28 days old) and the results are shown in Table 1.

TABLE 1
Animal Experiment Results

| | | experimental group |
|---|---|---|
| | Control group | (emulsion bio- |
| | (solid creep | fermented liquid |
| Items | feed) | feed) |
| Average initial weight/kg | 6.09 | 5.87 |
| Average final weight/kg | 7.01 | 7.20 |
| Average daily gain(g/day · head) | 131.43 | 189.71 |
| Average daily feed | 161.79 | 249.73 |
| Intake(g/day · head) | | |
| Feed conversion ratio | 1.23 | 1.32 |
| Diarrhea rate/% | 6.18 | 3.27 |
| Survival rate/% | 96.00 | 100.00 |

Note:
(1) when calculating the average daily feed intake, the weight of liquid material has been converted into the weight of solid material.

The results show that the average daily gain, average daily feed intake and survival rate of piglets fed with bio-fermented emulsion liquid feed are significantly higher than those of the control group, and the diarrhea rate is significantly lower than that of the control group. The feed conversion ratio of the experimental group is slightly higher than that of the control group, which is due to the fact that there is no special tank for liquid feed when feeding liquid feed, which results in a higher feed conversion ratio.

### Example 2

Impurities were removed from 200 kg of corn, 100 kg of broken rice, and 100 kg of wheat, which were crushed and then mixed evenly to prepare substrate of enzymolysis. α-amylase was added into substrate of enzymolysis at 50 U/g, and then 1200 kg of water was added, and mixed evenly to prepare enzymolysis slurry, which was raised to 90-95° C. for liquefaction enzymolysis for 30 min. Then, the temperature of enzymolysis slurry was adjusted to 55-60° C., β-amylase was added into substrate of enzymolysis at 300 U/g, pullulanase was added into substrate of enzymolysis at 0.3 ASPU/g, xylanase was added into substrate of enzymolysis at 15 U/g, β-glucanase was added into substrate of enzymolysis at 5 U/g, and the temperature was keep for enzymolysis for 10 h. Then, the temperature of enzymolysis slurry was adjusted to 35-38° C., lactobacillus was added into substrate of enzymolysis at 1×10⁶ CFU/g, neutral protease was added into substrate of enzymolysis at 20 U/g, and acid protease was added into substrate of enzymolysis at 50 U/g, and then anaerobic fermentation was carried out for 24 h under heat preservation, thus obtaining the component A.

Impurities were removed from 100 kg of soybean meal, which was crushed, 800 kg of water was added and mixed evenly, and then the temperature was raised to 80-85° C., and the temperature was kept for 30 min for sterilization. Then the temperature of the sterilized soybean meal solution was adjusted to 55-60° C., first the pH was adjusted to 9.0-9.5, then the alkaline protease was added into soybean meal at 1000 U/g, the temperature was kept for enzymolysis for 1 hours, and then the pH was adjusted to 7-7.5, neutral protease was added into soybean meal at 100 U/g, and mixed evenly to prepare enzymatic hydrolysis solution, and the temperature was kept for enzymolysis for 1 h. The temperature of the enzymolysis slurry was adjusted to 35-38° C., Lactobacillus was added into substrate of enzymolysis at 5×10⁶ CFU/g, acid protease was added into substrate of enzymolysis at 100 U/g, and then anaerobic fermentation was carried out for 30 h under heat preservation, thus obtaining the component B.

1600 kg of component A, 900 kg of component B and 500 kg of base material were mixed evenly to obtain bio-fermented liquid feed (complete bio-fermented liquid feed), wherein 500 kg of base material was obtained by evenly mixing the following raw materials: 8% puffed soybeans, 4% chocolate powder, 5% fish meal, 5% intestinal membrane protein powder, 4% yeast extract, 20% whey powder, 26% whole milk powder, 14% sucrose, 1.4% calcium hydrogen phosphate, 1% calcium formate, 5.6% fat powder and 6% premix feed.

The complete bio-fermented liquid feed was ground by colloid mill, then emulsified by emulsifying pump, finally homogenized by homogenizer to obtain a bio-fermented emulsion liquid feed with a particle size of 0.01-20 μm.

Animal Experiment:

100 weaned piglets aged 21 days were randomly divided into 2 treatment groups according to the principle of similar weight and the same sex, with 5 replicates in each treatment and 10 piglets in each replicate. Two kinds of experimental diets were fed separately: experimental feed A (control group, solid creep feed), experimental feed B (experimental group, bio-fermented emulsion liquid feed). During the experiment period, a dedicated person was arranged to be in charge of the feeding, piglets were kept in a naturally ventilated environment and free to eat and drink, and the shed was kept clean and sanitary. During the experiment period, if the piglets were found sick, they were treated in time, and if a piglet could not recover within 3 days, it was eliminated. A 7-day experiment was carried out (21 days old to 28 days old) and the results are shown in Table 2.

TABLE 2
Animal Experiment Results

| | | experimental group |
|---|---|---|
| | Control group | (emulsion bio- |
| | (solid creep | fermented liquid |
| Items | feed) | feed) |
| Average initial weight/kg | 7.09 | 7.09 |
| Average final weight/kg | 8.36 | 9.64 |
| Average daily gain(g/day · head) | 181.66 | 364.13 |
| Average daily feed | 333.03 | 435.78 |
| Intake(g/day · head) | | |
| Feed conversion ratio | 1.85 | 1.2 |
| Diarrhea rate/% | 7.48 | 3.7 |
| Survival rate/% | 96.00 | 100.00 |

Note:
(1) when calculating the average daily feed intake, the weight of liquid material has been converted into the weight of solid material.

The results show that the average daily gain, average daily feed intake and survival rate of piglets fed with bio-fermented emulsion liquid feed are significantly higher than those of the control group, while the diarrhea rate and feed conversion ratio of piglets fed with bio-fermented emulsion liquid feed were significantly lower than those of the control group.

The above are exemplary embodiments of the present application. It should be pointed out that for ordinary technical personnel in the field, some improvements and refinements can be made without departing from the principle of the application, and these improvements and refinements should also be considered as the scope of protection of the present application.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used in this specification and the appended claims, the singular forms “a,” “an” and “the” include plural references unless the content clearly dictates otherwise.

1-8. (canceled)

9. A preparation method for bio-fermented liquid feed, comprising the following steps:
(1) mixing corn, broken rice, barley and wheat in a weight ratio of 1:(0-5):(0-5):(0-5) to obtain a first substrate of enzymolysis;
(2) mixing the first substrate of enzymolysis obtained in step (1) with water, adding α-amylase according to the ratio of 1-1500 U per gram of the first substrate of enzymolysis, and raising the temperature to 60-120° C. for liquefaction enzymatic hydrolysis for 10-120 min to obtain a first enzymolysis slurry A;
(3) adjusting the temperature of the first enzymolysis slurry A obtained in step (2) to 40-80° C., adding β-amylase according to a ratio of 0-2000 U per gram of the first substrate of enzymolysis, adding pullulanase according to a ratio of 0-100 ASPU per gram of the first substrate of enzymolysis, adding glucoamylase according to a ratio of 0-5000 U per gram of the first substrate of enzymolysis, adding xylanase according to a ratio of 0-1000 U per gram of the first substrate of enzymolysis, adding β-glucanase according to a ratio of 0-1000 U per gram of the first substrate of enzymolysis, and enzymolyzing for 0-72 h to obtain a second enzymolysis slurry A;
(4) adjusting the temperature of the second enzymolysis slurry A obtained in step (3) to 25-40° C., adding Lactobacillus according to a ratio of 1×10⁵-1×10⁸ cfu per gram of the first substrate of enzymolysis, adding neutral protease according to a ratio of 1-1000 U per gram of the first substrate of enzymolysis, adding acid protease according to a ratio of 1-1000 U per gram of the first substrate of enzymolysis, and performing anaerobic fermentation for 10-72 h to obtain a component A;
(5) mixing and sterilizing soybean meal and water, adjusting the temperature to 40-70° C., adjusting the pH to 7-10, adding alkaline protease according to a ratio of 1-10000 U per gram of soybean meal, enzymolyzing for 0.5-6 h, then adjusting the pH to 6-8, adding neutral protease according to a ratio of 1-1000 U per gram of soybean meal, and enzymolyzing for 0.5-6 h to obtain a first enzymolysis slurry B;
(6) adjusting the temperature of the first enzymolysis slurry B obtained in step (5) to 25-40° C., adding Lactobacillus according to a ratio of 1×10⁵-1×10⁸ cfu per gram of soybean meal, adding acid protease according to a ratio of 1-1000 U per gram of soybean meal, and performing anaerobic fermentation for 10-72 h to obtain a component B;
(7) mixing the component A obtained in step (4) and the component B obtained in step (6) with a base material to obtain a bio-fermented liquid feed, the base material comprising the following components by mass percentage: 0-20% quick-breaking soybeans or puffed soybeans, 1-10% fish meal, 0-10% intestinal membrane protein powder, 1-10% yeast extract, 0-10% chocolate powder, 1-50% whey powder, 1-50% whole milk powder, 0-10% glucose, 1-20% sucrose, 0.1-5% calcium hydrogen phosphate, 0.1-5% calcium formate, 0.1-10% fat powder, and 2-10% premix feed;
wherein step (1) and step (5) are not limited in time sequence.

10. The preparation method according to claim 9, wherein the corn, broken rice, barley, and wheat of step (1) and the soybean meal of step (5) are crushed before being mixed with water.

11. The preparation method according to claim 9, wherein the weight ratio for mixing the first substrate of enzymolysis in step (1) and water is 1:(1-10).

12. The preparation method according to claim 9, wherein the weight ratio for mixing the soybean meal and water in step (5) is 1:(1-20).

13. The preparation method according to claim 9, wherein in step (7), the weight ratio of component A, component B, and base material is 100:(10-1000):(10-100).

14. A bio-fermented liquid feed prepared by the preparation method according to claim 9.

15. A bio-fermented emulsion liquid feed prepared by the preparation method according to claim 9, wherein the preparation method further comprises the steps of:
grinding, emulsifying, and homogenizing the bio-fermented liquid feed to obtain the bio-fermented emulsion liquid feed.

16. The bio-fermented emulsion liquid feed according to claim 15, wherein particle size of the bio-fermented emulsion liquid feed is 0.01-1000 μm.

17. The bio-fermented liquid feed according to claim 14, wherein the corn, broken rice, barley, and wheat of step (1) and the soybean meal of step (5) are crushed before being mixed with water.

18. The bio-fermented liquid feed according to claim 14, wherein the weight ratio of for mixing the first substrate of enzymolysis of step (1) and water is 1:(1-10).

19. The bio-fermented liquid feed according to claim 14, wherein the weight ratio of for mixing the soybean meal and water of step (5) is 1:(1-20).

20. The bio-fermented liquid feed according to claim 14, wherein in step (7), the weight ratio of component A, component B, and base material is 100:(10-1000):(10-100).

21. The bio-fermented emulsion liquid feed according to claim 15, wherein the corn, broken rice, barley, and wheat of step (1) and the soybean meal of step (5) are crushed before being mixed with water.

22. The bio-fermented emulsion liquid feed according to claim 15, wherein the weight ratio for mixing the first substrate of enzymolysis of step (1) and water is 1:(1-10).

23. The bio-fermented emulsion liquid feed according to claim 15, wherein the weight ratio for mixing the soybean meal and water of step (5) is 1:(1-20).

24. The bio-fermented emulsion liquid feed according to claim 15, wherein in step (7), the weight ratio of component A, component B, and base material is 100:(10-1000):(10-100).

25. The preparation method according to claim 16, wherein the corn, broken rice, barley, and wheat of step (1) and the soybean meal of step (5) are crushed before being mixed with water.

26. The preparation method according to claim 16, wherein the weight ratio for mixing the first substrate of enzymolysis of step (1) and water is 1:(1-10).

27. The preparation method according to claim 16, wherein the weight ratio for mixing the soybean meal and water of step (5) is 1:(1-20).

28. The preparation method according to claim 16, wherein in step (7), the weight ratio of component A, component B, and base material is 100:(10-1000):(10-100).
